(19) United States
(12) Patent Application Publication
(10) Pub. No.: US 2004/0187143 A1
(43) Pub. Date: Sep. 23, 2004

(54) Portable disc player with disc storage compartment

(76) Inventors: Boris Tolkachev, Jersey City, NJ (US); Victor Okhotskiy, Moscow (RU)

Correspondence Address: Boris Tolkachev, 39 SOUTH PAYNE AVE, RUNNEMEDE, NJ, 08078, US

(21) Appl. No.: 10/646,118

(22) Filed: Aug. 23, 2003

Related U.S. Application Data
(60) Provisional application No. 60/455,333, filed on Mar. 17, 2003.

(51) Int. Cl. G11B 17/03; G11B 17/04

(52) U.S. Cl. 720/655

(57) ABSTRACT

A player apparatus for compact discs and similar signal carriers provided with a disc storage unit. The storage unit having the disc holder for holding discs arranged as an integral part of player apparatus. Storage unit arranged to store discs in a manner which allow placing stored discs parallel to the disc which is positioned into drive for playback/recording, therefore the allowing storing additional discs without significant increasing of external dimensions of the player apparatus.

### CROSS-REFERENCE TO RELATED APPLICATION This application is entitled to the benefit of Provisional Patent Application No. 60/455,333 filed 2003 Mar. 03.

### FEDERALLY SPONSORED RESEARCH

Not Applicable

### SEQUENCE LISTING OR PROGRAM

Not Applicable

### BACKGROUND OF THE INVENTION—FIELD OF THE INVENTION

This Invention relates to a disc player device, and in particular, to disc player device comprising disc storage compartment for storing additional discs available for playback when it is desirable.

### BACKGROUND OF THE INVENTION

Conventionally, discs to be used in a disc player are stored in a separate disc holder. However, using a separate disc holder is inconvenient if a small number of discs are intended to be used in a period of time, especially when the disc player is personal portable device using for entertainment during trips, transportation, or when usage of an additional room for storage of discs is undesirable.

U.S. Pat. No. 6,222,809 by Totsuka discloses compact disc player with transparent lid having slot for displaying compact disc jacket art, with one of the embodiments having an additional slot formed in the lid to receive and store a compact disc. In addition to the fact that the only transparent rectangular lid with dimensions defined by album cover is described, a primary disadvantage of the design disclosed is that unavoidable scratching of surface of compact disc will take place during compact disc insertion and releasing into and out of the storage slot of design described and no means for dust and fine particles protection are disclosed.

### SUMMARY OF THE INVENTION

Embodiments of the present invention are to provide a disc player apparatus with a disc storage unit arranged as an integral part of the player apparatus. Disc player apparatus comprise storage unit has at least one storage compartment for receiving and storing thereto at least one disc. Thereby, a user who uses a disc player apparatus can handle more than one disc easily and efficiently, without using a separate disc holders, boxes or cases.

The storage unit incorporates at least one storage compartment. The storage compartment constructed to avoid scratching of the stored disc surface during disc inserting and taking out. The disc storage compartment could be positioned in different members of the disc player—in member, where the disc drive is situated or in lid, and may be constituted by soft cases, grooves, slots, continuous ridges, discontinuous ridges.

The storage compartments of the embodiments of the present invention are positioned in a manner, that when disc player apparatus is loaded, stored discs are parallel to the disc in drive which is reproduced to provide minimal increase in the external dimensions of the player apparatus.

To ensure secure holding of the discs stored, the disc storage compartment could be provided by lock improvement.

The disc player device comprising the disc drive and the disc storage as a single unit may be implemented for any disc reading/writing apparatus such as an optical disc drive, magnetic disc and similar signal carriers.

### BRIEF DESCRIPTION OF THE DRAWINGS

FIG. 1A is a perspective view illustrating first embodiment of the disc player according to the present invention.

FIG. 1B is a perspective view illustrating first embodiment of the disc player according to the present invention with one disc placed into the first storage compartment, and second disc under insertion to the another storage compartment.

FIG. 1C is an elevation view of a lid of the disc player apparatus, as seen from internal side of the player apparatus, in accordance with the first embodiment of the disc player apparatus of the present invention.

FIG. 1D is a partial cross-sectional view illustrating first embodiment of the disc player according to the present invention illustrated in FIG. 1A as seen along section line 1D-1D of FIG. 1C.

FIG.2A is a perspective view illustrating second embodiment of the disc player according to the present invention wherein discs placed to the disc holders of storage compartment are pre-inserted into individual soft envelopes to avoid scratching of the surface of the disc stored.

FIG.2B is a perspective view illustrating second embodiment of the disc player according to the present invention with one enveloped disc placed into the first storage compartment, and second envelope under insertion to the second storage compartment. Insertion of the disc into envelope is shown.

FIG. 2C is an elevation view of the lid of the disc player apparatus, as seen from internal side of the player apparatus, in accordance with the second embodiment of the present invention.

FIG. 2D is a partial cross-sectional view illustrating second embodiment of the embodiments of the disc player according to the present invention illustrated in FIG. 2A as seen along section line 2E-2E of FIG. 2D.

FIG. 3A. is a perspective view illustrating third embodiment of the disc player according to the present invention.

FIG. 3B is a perspective view illustrating third embodiment of the disc player according to the present invention with one disc placed into the one storage compartment, and second disc under insertion to another storage compartment.

FIG. 3C is a partial cross-sectional view illustrating third embodiment of the disc player according to the present invention illustrated in FIG. 3A as seen along section line 3C-3C of FIG. 3B.

FIG. 3D is a perspective view illustrating third embodiment of the disc player according to the present invention.

FIG. 4A. is a perspective view illustrating fourth embodiment of the disc player according to the present invention.

FIG. 4B is a perspective view illustrating fourth embodiment of the disc player according to the present invention with one disc placed into the first storage compartment, and another disc under insertion to the second storage compartment.

FIG. 4C is a partial cross-sectional view illustrating fourth embodiment of the disc player according to the present invention illustrated in FIG. 4A as seen along section line 4C-4C of FIG. 4B.

FIG. 5A. is a perspective view illustrating fifth embodiment of the disc player according to the present invention.

FIG. 5B. is a side view illustrating one of the details (lid of the disc player) of the fifth embodiment of the disc player according to the present invention.

FIG. 5C. is a cross-sectional view illustrating fifth embodiment of the disc player according to the present invention illustrated in FIG. 5A as seen along section line 5C-5C of FIG. 5B.

FIG. 5D. is a cross-sectional view illustrating fifth embodiment of the disc player according to the present invention illustrated in FIG. 5A as seen along section line 5D-5D of FIG. 5B.

FIG. 5E is partial perspective view of the lid of the player apparatus according to the fifth embodiment of the present invention.

FIG. 6A. is a perspective view illustrating sixth embodiment of the disc player according to the present invention.

FIG. 6B is a perspective view illustrating sixth embodiment of the disc player according to the present invention with one disc placed into the storage compartment.

FIG. 7A is a perspective view illustrating seventh embodiment of the disc player according to the present invention with one disc under insertion into the storage compartment.

FIG. 7B is another perspective view illustrating seventh embodiment of the disc player according to the present invention.

FIG. 7C. is a cross-sectional view illustrating seventh embodiment of the disc player according to the present invention illustrated in FIG. 7A as seen along section line 7C-7C of FIG. 7B.

FIG. 7D. is a cross-sectional view illustrating seventh embodiment of the disc player according to the present invention illustrated in FIG. 7A as seen along section line 7D-7D of FIG. 7B.

FIG. 8A is a perspective view illustrating eight embodiment of the disc player according to the present invention with one disc inserted into the storage compartment.

FIG. 8B is an elevation view of a lid of the disc player apparatus, as seen from internal side of the player apparatus, in accordance with the eight embodiment of the disc player apparatus of the present invention.

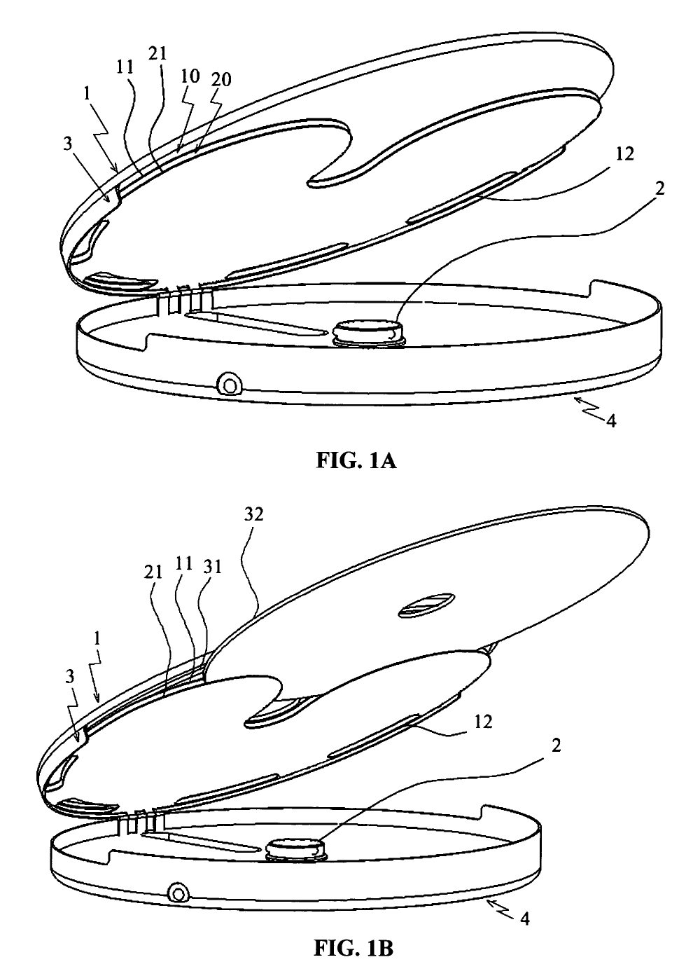

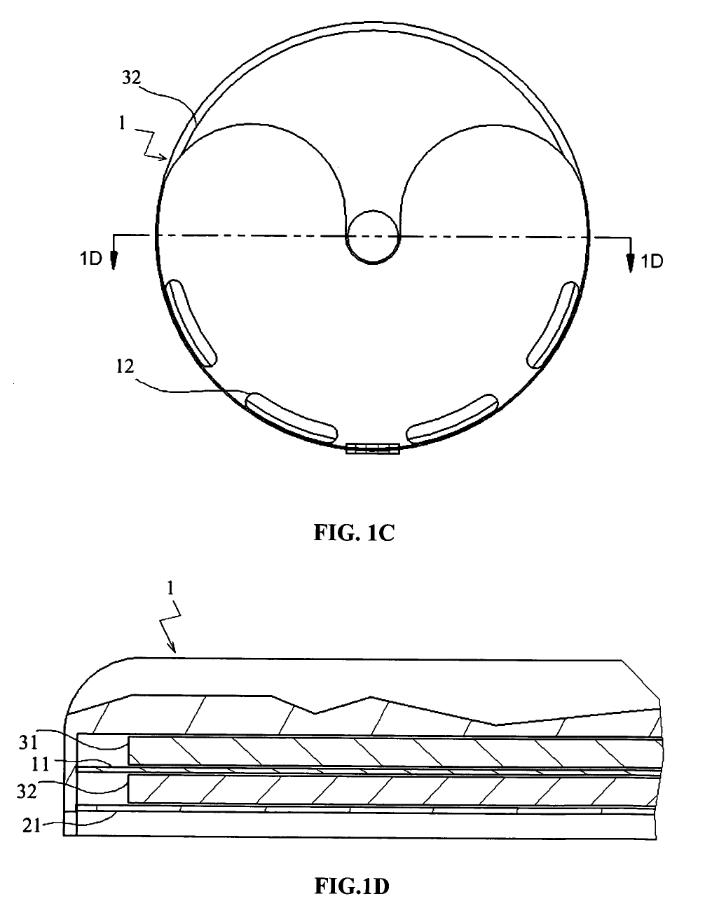

### DETAILED DESCRIPTION—FIG. 1A—PREFERRED EMBODIMENT

FIG. 1A shows the construction of a disc player according to the first embodiment of the present invention. The disc player comprises a player drive unit 4, a lid 1, and a disc storage unit 3 arranged in the lid 1 of the player apparatus. Disc storage unit 3 comprises two separate disc storage compartments 10, 20, arranged on an internal, adjacent to turntable 2 of the player drive unit 4, side of lid 1. Disc storage compartment 10 arranged between internal, adjacent to turntable 2 of the player drive unit 4, side of the lid 1 and a carrier plate 11. Disc storage compartment 20 arranged between a carrier plate 11 and the carrier plate 21. Each of the compartments 10, 20 have longitudinal and vertical dimensions larger than the diameter and thickness of the stored disc correspondingly. Each of the compartments 10, 20 are arranged for holding individual disc.

Carrier plates 11, 21 made of soft plastics or textile to avoid scratching of discs placed into storage compartment. Apertures 12 are arranged on carrier plates 11, 21 in order to allow fine particles and dust to drop out from disc storage compartments 10, 20, preventing accumulation of fine particles and dust, and thereby eliminating undesirable scratching of the surface of discs during insertion and taking out.

Referring FIGS. 1B, 1C, 1D, the first embodiment of the present invention is shown. When the lid unit 1 is in open position, compact discs 31, 32 could be placed to the turntable 2 of the player's deck 4, into one of two storage compartments: storage compartment 11 and storage compartment 12. When lid 1 of the player apparatus is in close position, the disc storage compartments 10, 11 of the storage unit 3 and compact discs 31 and 32 inserted thereto and held therein situated parallel and spatially apart from turntable 2 of the drive unit 4, allowing performing playback and record operations upon disc placed in driver unit 4.

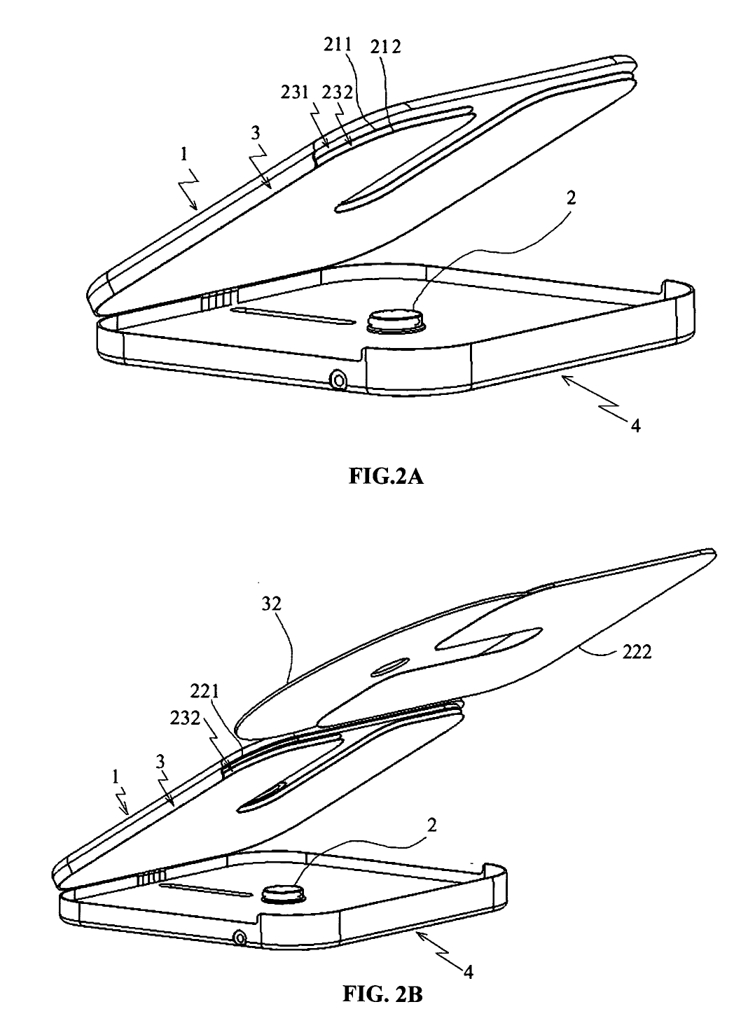

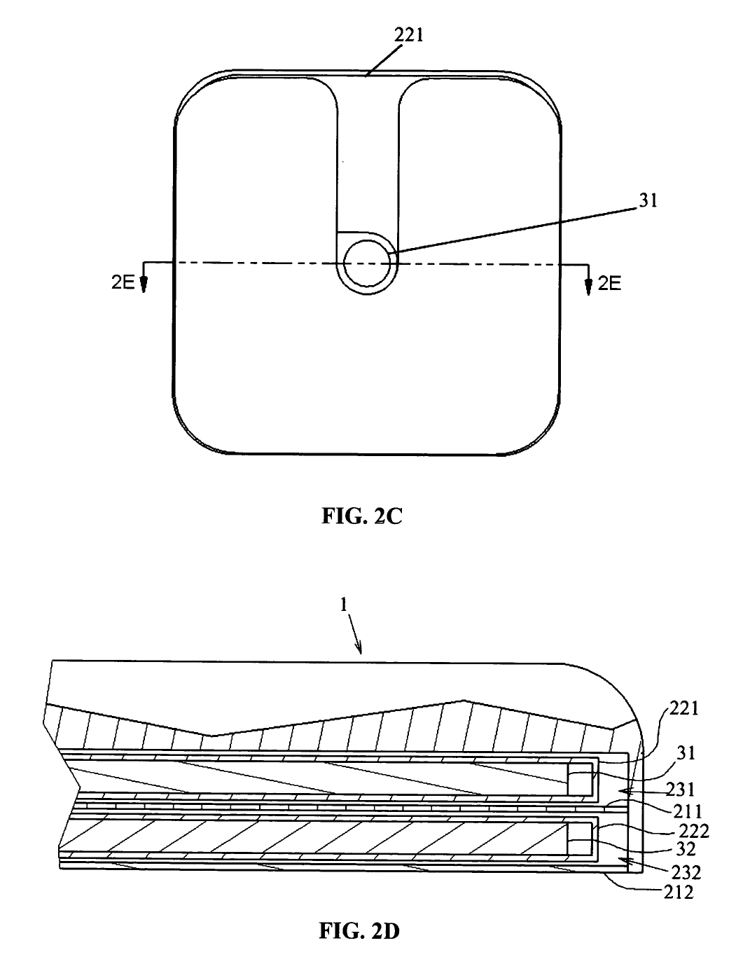

FIG. 2A shows the construction of a disc player according to the second embodiment of the present invention. The disc player 1 comprises a player drive unit 4, a lid 1, and a disc storage unit 3 arranged in the lid 1. Disc storage unit 3 comprises two separate disc storage compartments 231, 232, arranged on an internal, adjacent to turntable 2 of the player drive unit 4, side of lid 1. Disc storage compartment 231 arranged between internal, adjacent to turntable 2 of the player drive unit 4, side of the lid 1 and a carrier plate 211. Disc storage compartment 232 arranged between a carrier plate 211 and the carrier plate 212.

As shown at FIGS. 2B, disc storage compartments 231 and 232 of the second embodiment of the present invention arranged to store discs 31, 32, pre-inserted into individual envelopes 221, 222. Individual envelopes 221, 222 are arranged to avoid scratching compact disc surface during inserting and taking out of stored discs.

Each of the compartments 231, 232 have longitudinal and vertical dimensions larger than the longitudinal and vertical dimensions of the individual disc envelopes 221, 222. Each of the compartments 231, 232 are arranged for holding individual envelope with disc pre-inserted into it.

Referring FIGS. 2C, 2D, the second embodiment of the present invention is shown. When the lid unit 1 is in open position, compact discs 31, 32 could be placed in the turntable 2 of the player's deck 4.Compact discs 31, 32 being pre-inserted into envelopes 221, 222 correspondingly, could be placed into two storage compartments: compartment 231 and/or compartment 232. When lid 1 is in close position, the disc storage compartment unit 3 and compact discs 31 and 32 in envelopes 221, 222, inserted thereto and held therein situated parallel and spatially apart from turntable 2 of the drive unit 4, allowing performing playback and record operations upon disc placed in driver unit 4.

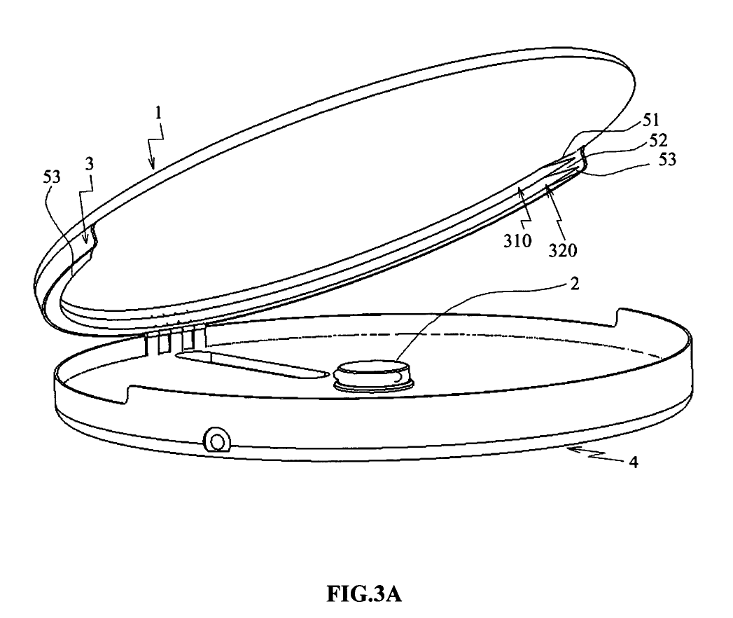

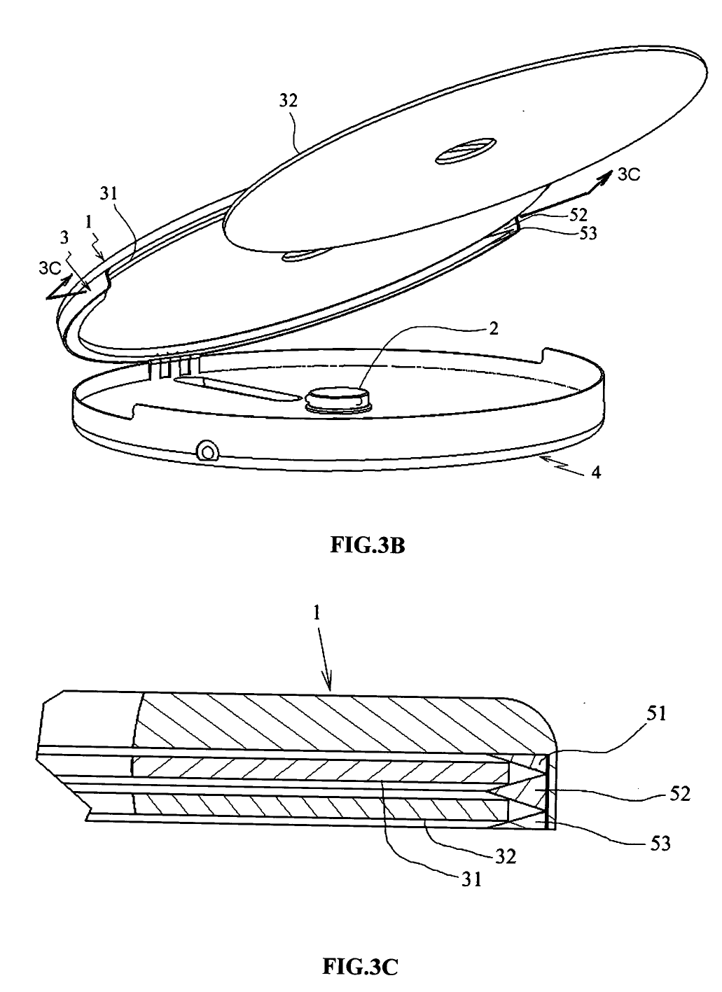

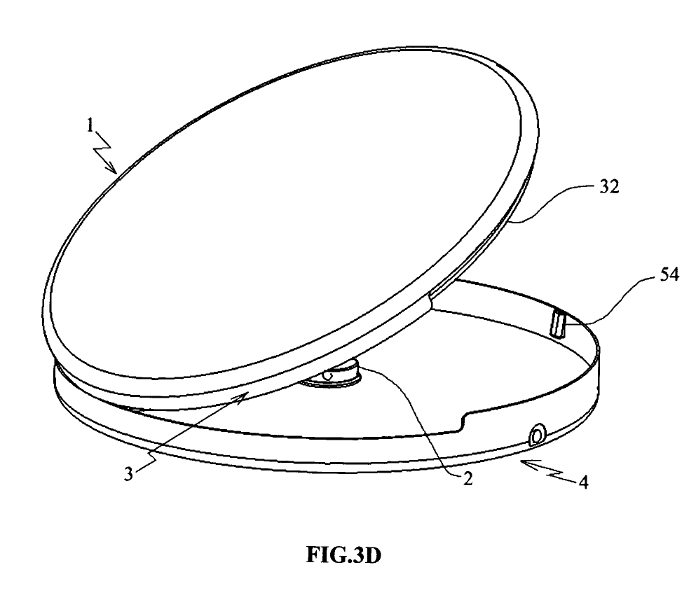

FIG. 3A shows the construction of a disc player according to the third embodiment of the present invention. The disc player 1 comprises a player drive unit 4, a lid 1, and a disc storage unit 3 arranged in the lid 1. Disc storage unit 3 comprises two disc storage compartments arranged on an internal, adjacent to turntable 2 of the player drive unit 4, side of lid 1. Two ridges 51 and 52 form disc storage compartment 310. Two ridges 52 and 53 form storage compartment 320.

As shown at the FIGS. 3B, 3C, when discs 31, 32 are inserted into storage compartments 310, 320 of unit 3, peripheral rim of disc 31 is situated in groove between ridges 51, 52, and peripheral rim of disc 31 is situated in groove between ridges 52, 53, and thereby, discs 31, 32 are fixed in the storage compartments 310, 320 consequently.

Referring FIG. 3D, the third embodiment of the present invention is shown. When the lid unit 1 is in close position, compact discs 31, 32 placed into storage compartments 310, 320, rested against a ledge 54, and thereby, positions of discs 31, 32 in storage compartments 310, 320 are reliably fixed.

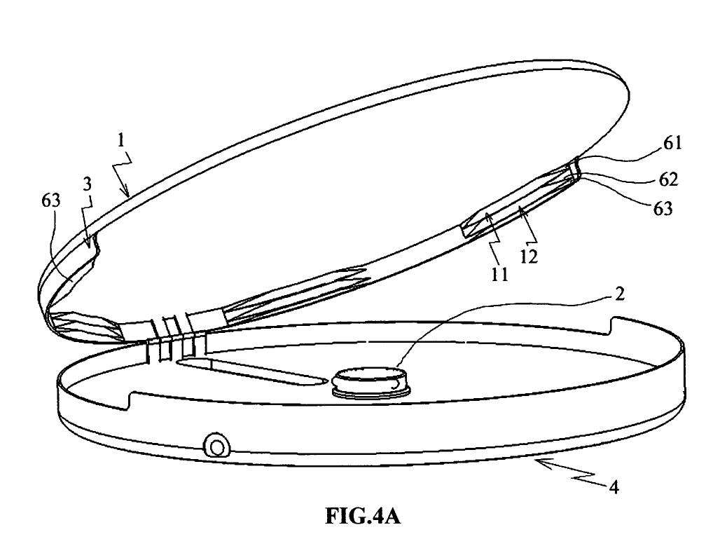

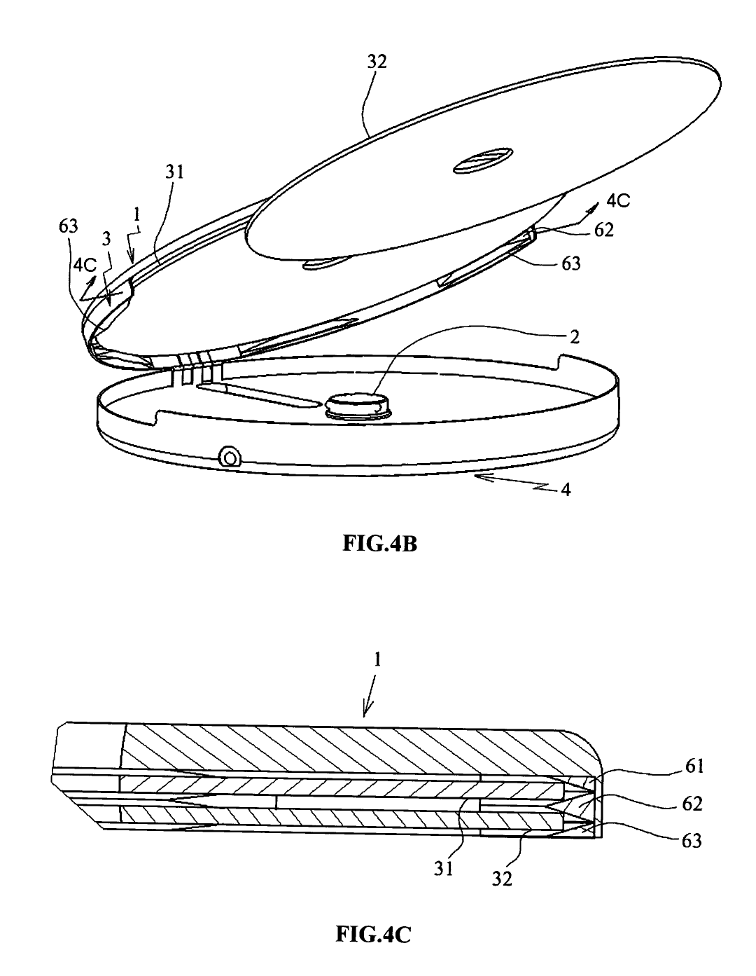

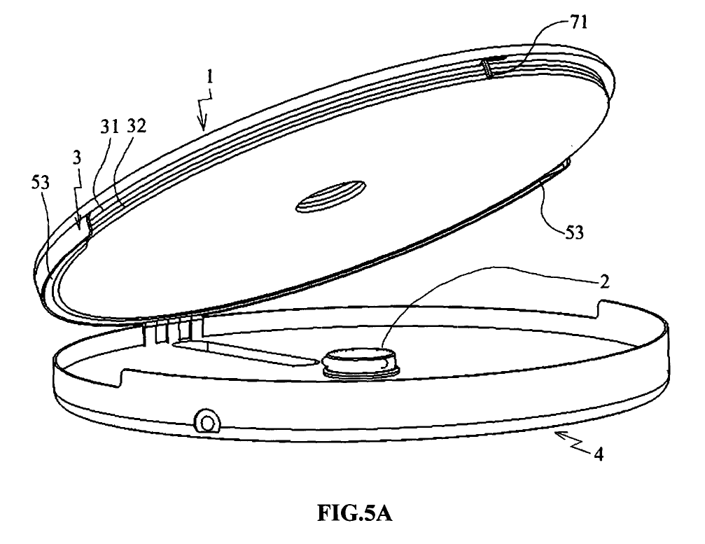

FIGS. 4A-4C show the construction of a disc player according to the fourth embodiment of the present invention. The fourth embodiment of the present invention differs from the third embodiment by discontinued shape of ridges 61, 62, 63 arranging the disc storage compartments of the disc storage unit.

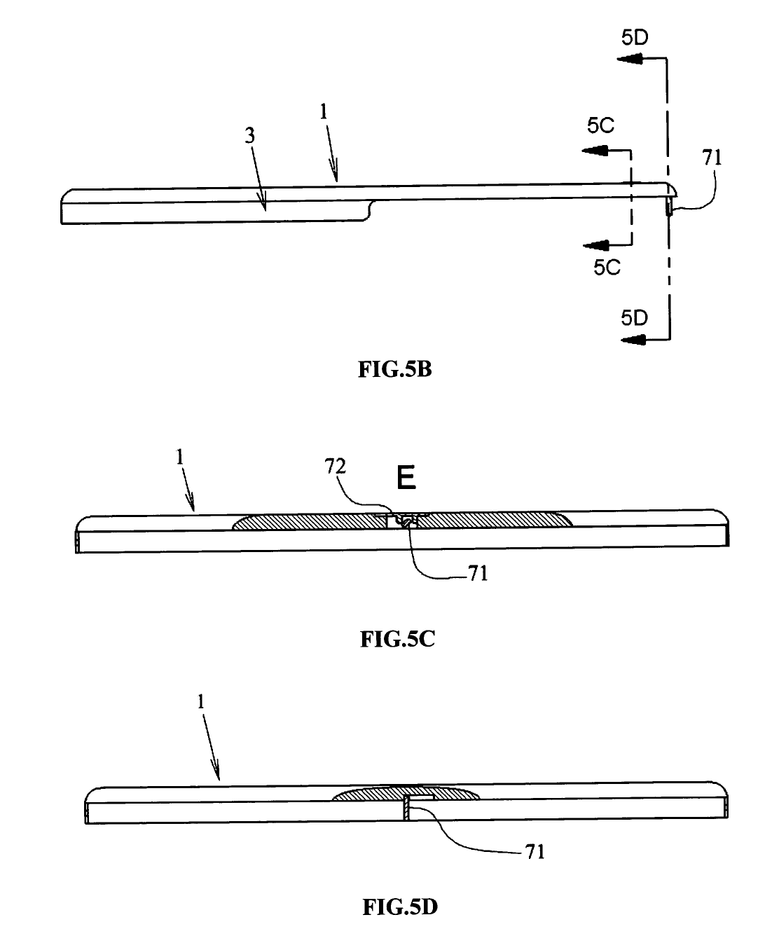

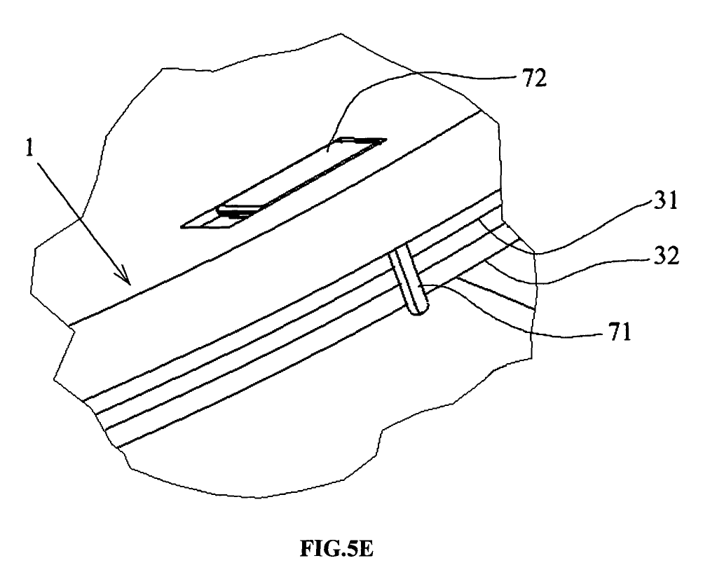

FIGS. 5A-5E show fifth embodiment of the present invention, which is differs from the third embodiment of the present invention by the presence of stopper lever 71 and sliding button 72. To avoid loss of discs 31, 32 from the disc storage compartments 10, 20, stopper lever 71 is arranged. To pull out disks, the stopper lever 71 should be revolved by means of movement of the sliding button 72 arranged on the lid 1 of the player apparatus.

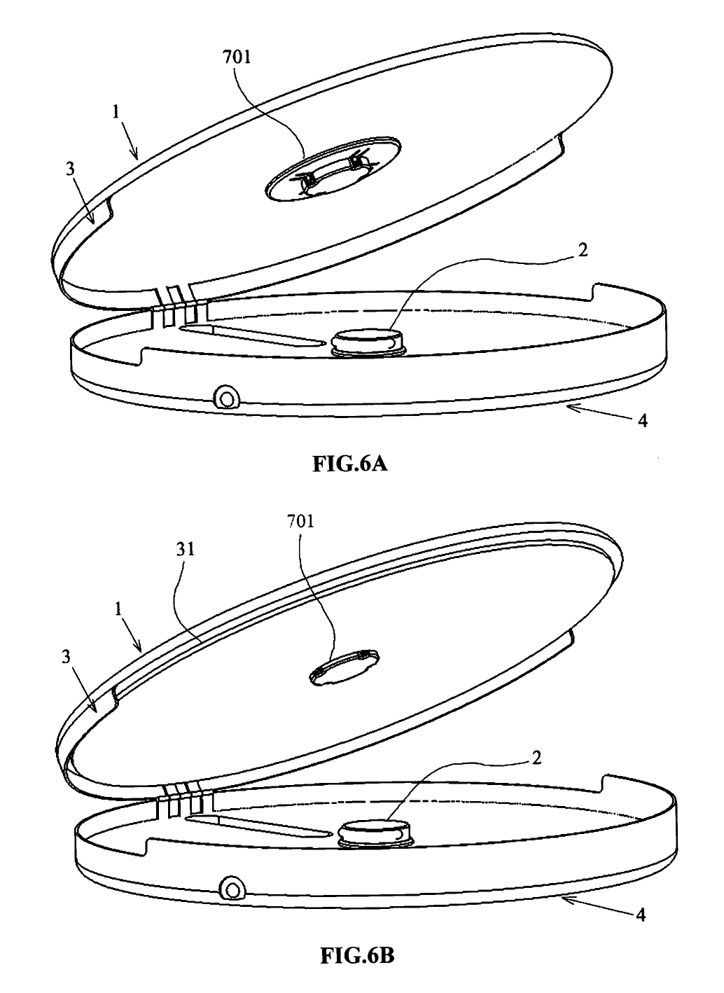

FIGS. 6A-6B show the construction of a disc player according to the sixth embodiment of the present invention. The disc player 1 comprises a player drive unit 4, a lid 1, and a disc storage unit 3 arranged in the lid 1. Disc storage unit 3 comprises one disc storage compartment arranged on an internal, adjacent to turntable 2 of the player drive unit 4, side of lid 1. Central disc holder 711 having resilient elements implemented for holding disc 31 in storage compartment. Disc holder arranged for holding disc dressed on it is well known and widely used for fixing compact discs in disc boxes.

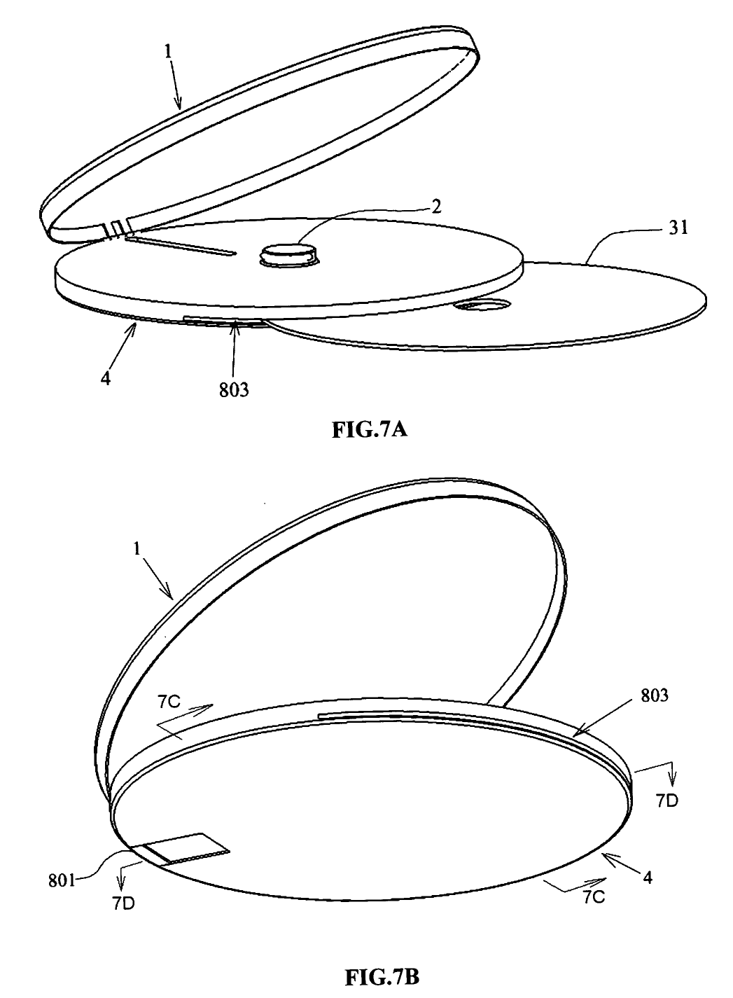

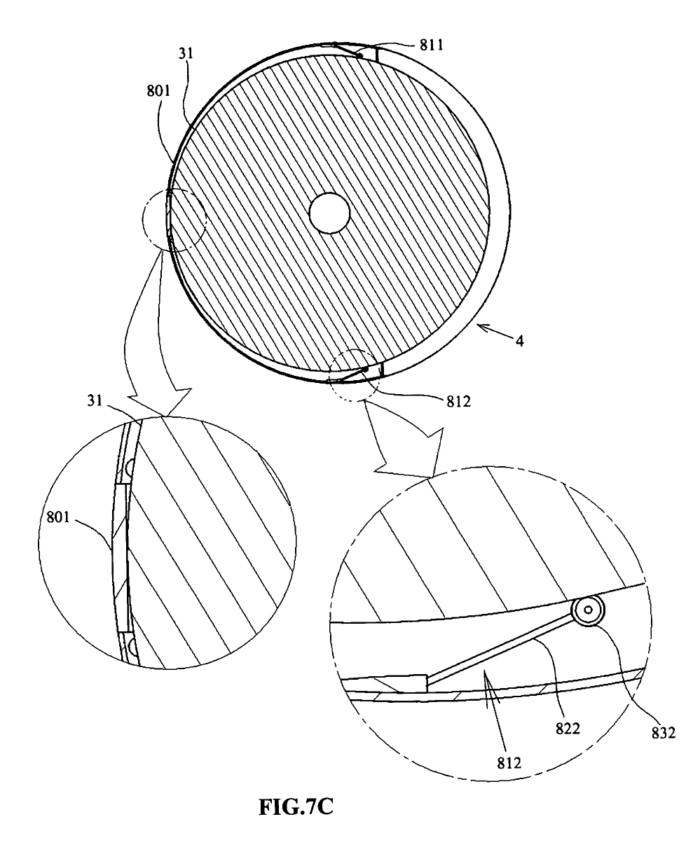

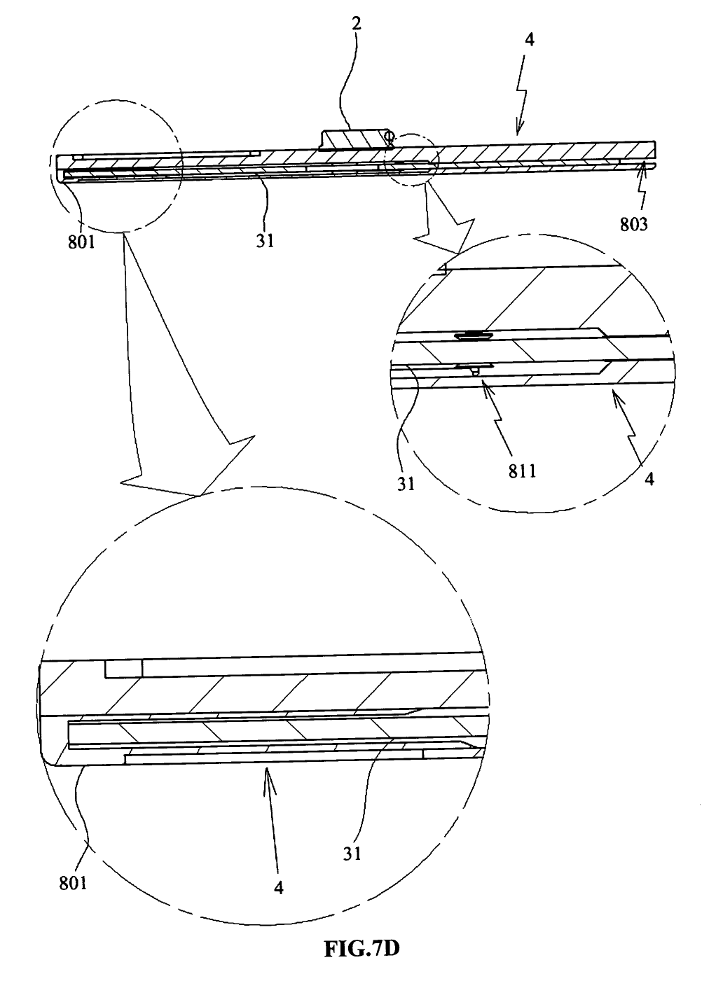

FIGS. 7A-7D show the construction of a disc player according to the seventh embodiment of the present invention. Disc storage unit comprises one disc storage compartment 803 arranged in the player drive unit 4. Disc storage compartment 803 arranged between external, opposite to the player's lid 1 wall of the corpse of the player drive unit 4 and a mechanism of turntable 2.

Disc holders 811 and 812 are implemented for holding disc in storage compartment 803.

Disc holder 812 is shown on FIG. 7C. Disc holder consists of resilient arm 812 and a roller 832. When disk 31 is under insertion into the storage compartment 803, rotation of roller 832 allows disc movement without scrapping disc surface. When disk 31 is inserted, resilient arm 822 of disk holder 812 provides force necessary to hold disk in the storage compartment.

Disc holder 811 construction is the same as one of the disc holder 812.

For extraction of disc 31 from the storage compartment 803 a sliding button 801 is implemented. Extraction of the disc 31 is carried out by moving the sliding button 801 of the player apparatus.

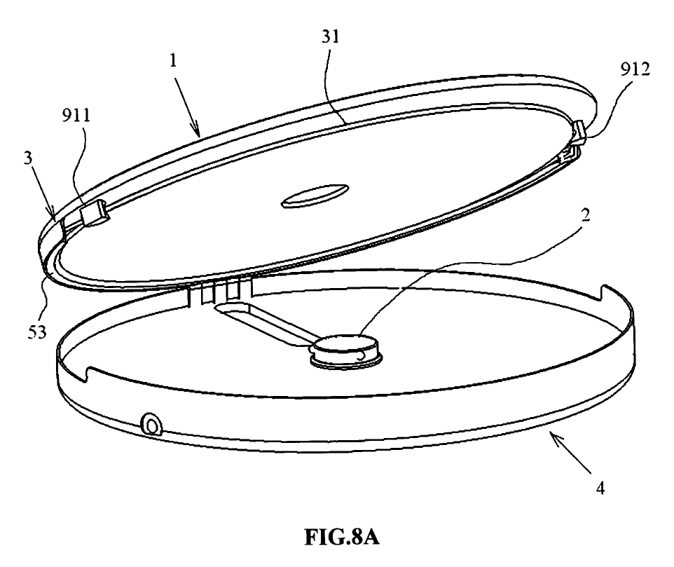

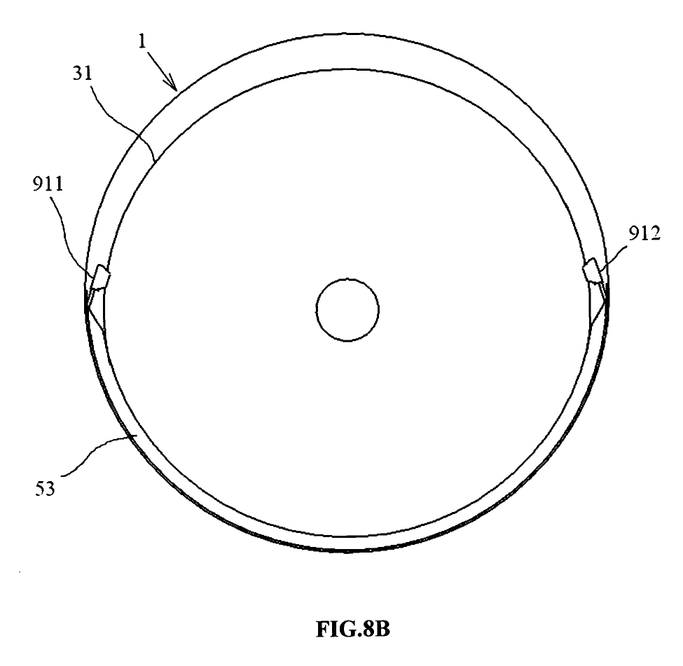

FIGS. 8A, 8B show the construction of a disc player according to the eight embodiment of the present invention. Disc storage unit comprises one disc storage compartment 803 arranged in the player lid 3. Disc storage compartment arranged on internal, adjacent to the player's drive unit 4 side of the lid 3. Resilient disc holders 911 and 912 hold disc in storage compartment and thereby prevent spontaneous disc loss.

### ADVANTAGES

From the description above, a number of advantages of the compact disc player with disc storage compartment described become evident:

Presence of the disc storage compartment in the compact player of the present invention not leads to substantial increasing of the dimensions of the player. It also not leads to significant changing in design of compact player and rising of manufacturing costs.

Since the storage compartment of many of the embodiments of the present inventions is arranged on the internal, adjacent to the turntable side of the lid of the player apparatus, no additional protection against dust and fine particles is necessary in said embodiments.

Design of the storage compartments described eliminates undesirable scratching of surface of the stored discs by dust and fine particles during discs insertion and releasing.

In the embodiments shown, the invention is applied to compact disc players, but it can also be applied to a MPEG-3, DVD, Mini-Disc and other similar playing and recording apparatuses. It can also be applied to disc playing and recording apparatuses of type other than compact disc type.

It will be apparent to those skilled in the art from this disclosure that embodiments of the present invention can have fewer or more storage compartments for storing discs.

Since certain changes may be made in the above portable disc player having disc storage compartment without departing from the scope of the invention herein involved, it is intended that all matter contained in the above description or shown in the accompanying drawing shall be interpreted in an illustrative and not in a limiting sense.

1. A portable disc player for playing back and recording compact discs, MP-3 discs, DVD, and other similar signal carriers comprising:
a. a player body with plan dimensions substantially equal to plan dimensions of a compact disc having a playing mechanism within the body including a spinning capstan for supporting and rotating a disc and a head for reading the disc;
b. a lid with plan dimensions substantially equal to plan dimensions of a compact disc, said lid pivotally connected to the player body for movement between a closed position lying flat against the player body and an open position revealing the spinning capstan;
c. means for storing at least one compact disc on internal, adjacent to said spinning capstan, side of said lid, so as to be able to hold said stored compact disc in interior of the player apparatus in position substantially parallel to surface of said spinning capstan, when said lid is in closed position.

2. The portable disc player of claim 1 wherein said means for storing discs comprise carrier plates, made of plastics, textile or like material, so as to be able to carry stored discs in slots arranged between carrier plates.

3. The portable disc player of claim 2 wherein said carrier plates have apertures.

4. The portable disc player of claim 1 wherein said means for storing comprise grooves and ridges, arranged on internal perimeter of said lid, adapted for adjoining ridge of the disc stored.

5. The portable disc player of claim 1 wherein said means for storing comprises central disc holder situate on internal surface of said lid, so as to be able to hold the disc stored by coupling with the central aperture of said disc.

6. The portable disc player of claim 1 wherein said means for storing comprise locking means so as to be able to prevent an undesirable releasing of stored discs.

7. The portable disc player of claim 1 wherein said means for storing discs comprise resilient holding levers adapted for adjoining outer ridge of stored disc so as to be able to prevent an undesirable releasing of stored discs.

8. A portable disc player for playing back and recording compact discs, MP-3 discs, DVD, and other similar signal carriers comprising:
a. a player body with plan dimensions substantially equal to plan dimensions of a compact disc having a playing mechanism within the body including a spinning capstan for supporting and rotating a disc and a head for reading the disc;
b. a lid with plan dimensions substantially equal to plan dimensions of a compact disc, said lid pivotally connected to the player body for movement between a closed position lying flat against the player body and an open position revealing the spinning capstan;
c. means for storing at least one compact disc in interior of said body of player apparatus in position substantially parallel to surface of said spinning capstan.

9. The portable disc player of claim 8 wherein said means for storing comprise carrier plates, made of plastics, textile or like material, so as to be able to carry stored discs in slots arranged between carrier plates.

10. The portable disc player of claim 9 wherein said carrier plates have apertures.

11. The portable disc player of claim 8 wherein said means for storing discs comprise locking means so as to be able to prevent an undesirable releasing of stored discs.

12. The portable disc player of claim 8 wherein said means for storing comprise resilient holding levers adapted for adjoining outer ridge of stored disc so as to be able to prevent an undesirable releasing of stored discs.
